(19) United States
(12) Patent Application Publication
(10) Pub. No.: US 2024/0298856 A1
(43) Pub. Date: Sep. 12, 2024

(54) VACUUM CLEANER

(71) Applicant: SAMSUNG ELECTRONICS CO., LTD., Suwon-si (KR)

(72) Inventors: Kyoungwoung KIM, Suwon-si (KR); Kihwan KWON, Suwon-si (KR)

(73) Assignee: SAMSUNG ELECTRONICS CO., LTD., Suwon-si (KR)

(21) Appl. No.: 18/661,003

(22) Filed: May 10, 2024

Related U.S. Application Data
(63) Continuation of application No. PCT/KR2022/018022, filed on Nov. 15, 2022.

(30) Foreign Application Priority Data
Jan. 12, 2022 (KR) 10-2022-0004738

(51) Int. Cl. A47L 9/04; A46B 9/02; A46B 13/00; A46B 13/02; A46B 15/00; A47L 5/26; A47L 9/06

(52) U.S. Cl. CPC A47L 9/0488; A46B 9/026; A46B 13/001; A46B 13/02; A46B 15/0065; A47L 5/26; A47L 9/0477; A47L 9/0613; A46B 2200/3033

(57) ABSTRACT

A vacuum cleaner includes a main body including a fan, a motor connected to the fan, and configured to rotate the fan to generate an intake force, and an intake head connected to the main body to guide foreign substances to be drawn into the main body therethrough by the intake force. The intake head includes a housing including an inlet, a drum brush rotatable within the housing to allow the foreign substances to be drawn into the housing through the inlet, and the drum brush including a drum body and a brush on an outer circumference of the drum body, and a cutter adjacent to the brush and including a plurality of cutting edges arranged along an axial direction of the drum brush to allow the foreign substances wound on the drum brush to be cut and removed from the drum brush.

### CROSS REFERENCE TO THE RELATED APPLICATION

This application is a continuation application, filed under 35 U.S.C. § 111(a), of International Application PCT/KR2022/018022 filed Nov. 15, 2022, and is based on and claims priority under 35 U.S.C. § 119 to Korean Patent Applications No. 10-2022-0004738, filed on Jan. 12, 2022 in the Korean Intellectual Property Office, the disclosures of which are incorporated by reference herein in their entireties.

### TECHNICAL FIELD

The present disclosure relates to a vacuum cleaner having an intake head equipped with a drum brush rotating, and more particularly, to a vacuum cleaner having a structure for removing foreign substances wound around the drum brush.

### BACKGROUND ART

In general, a vacuum cleaner, a home appliance for cleaning, includes a suction force generating device that generates a suction force, a suction head that draws in air and foreign substances from a surface to be cleaned by the suction force of the suction force generating device, and a foreign substance collecting chamber that separates and collects foreign substances from the air drawn through the intake head.

The suction head may include a housing having an inlet, and a drum brush that sweeps the surface to be cleaned and guides foreign substances on the surface to be cleaned to be efficiently drawn into the inlet. The drum brush may be connected to a drive unit to be rotatable.

The drum brush includes a drum body and a brush arranged around the drum body. As the drum brush rotates, foreign substances, such as hair, animal fur, thread, etc. drawn through the inlet may be caught by and wound around the brush.

### DISCLOSURE

### Technical Problem

The present disclosure provides a vacuum cleaner having a structure capable of removing foreign substances, such as hair, animal fur, thread, and the like, wound on a drum brush, from the drum brush.

Further, the present disclosure provides a vacuum cleaner having a structure capable of cutting foreign substances removed from a drum brush.

### Technical Solution

A vacuum cleaner may include a main body including a fan, a motor connected to the fan, and configured to generate an intake force, and an intake head connected to the main body to guide foreign substances to be drawn into the main body therethrough by the intake force. The intake head may include a housing including an inlet, a drum brush rotatable within the housing to allow the foreign substances to be drawn into the housing through the inlet, the drum brush including: a drum body and a brush on an outer circumference of the drum body, and a cutter adjacent to the brush, and the cutter including a plurality of cutting edges arranged along an axial direction of the drum brush to allow the foreign substances wound on the drum brush to be cut and removed from the drum brush.

The plurality of cutting edges may protrude toward the brush and is arranged to be spaced apart from each other, and the cutter may further include a catching groove concavely formed between the plurality of adjacent cutting edges such that the foreign substances removed from the drum brush are caught.

The plurality of cutting edges may extend along a circumferential direction of the drum brush and is inclined with respect to a direction perpendicular to the axial direction of the drum brush.

The cutter may further include a left cutting portion and a right cutting portion disposed on the left and right in the axial direction of the drum brush, and the plurality of cutting edges included in the right cutting portion may be inclined in an opposite direction to the plurality of cutting edges included in the left cutting portion.

The cutter may further include an upstream cutting portion, a downstream cutting portion disposed on a downstream side of the upstream cutting portion with respect to a direction of rotation of the drum brush, and a cutting groove recessed between the upstream cutting portion and the downstream cutting portion in a direction opposite to a protruding direction of the cutting edges, the cutting groove including an upstream edge having a corner bent from the upstream cutting portion and a downstream edge having a corner bent from the downstream cutting portion.

The downstream cutting portion may include a pair of adjacent cutting edges, and the upstream cutting portion includes a cutting edge disposed between the pair of adjacent cutting edges of the downstream cutting portion in the axial direction of the drum brush.

The plurality of cutting edges included in the upstream cutting portion may be inclined in an opposite direction to the plurality of cutting edges included in the downstream cutting portion.

The upstream cutting portion may include a first cutting portion and a second cutting portion respectively disposed on the left and right in the axial direction of the drum brush, the downstream cutting portion may include a third cutting portion and a fourth cutting portion respectively disposed on the left and right in the axial direction of the drum brush, and the plurality of cutting edges included in the first cutting portion and the fourth cutting portion may be inclined in opposite directions to the plurality of cutting edges included in the second cutting portion and the third cutting portion.

The plurality of cutting edges may extend along a circumferential direction of the drum brush, and upper ends of the plurality of cutting edges may protrude to form a curve corresponding to a rotational trajectory of the brush.

The intake head may further include a blade extending along the axial direction of the drum body around the brush to prevent the foreign substances from being caught in the brush, and the brush may protrude further in a radial direction of the drum body than the blade.

A maximum height from a lower end of the catching groove to an upper end of the cutting edge may correspond to a height at which the brush protrudes further in the radial direction of the drum body than the blade.

The housing may include a connection hole to allow the foreign substances drawn into the housing to move to the main body therethrough, and the cutter may be disposed on a rear side of the drum brush and on an upper portion of the connector.

The cutter may be provided parallel to an axis of rotation of the drum brush.

The intake head may further include a cutter housing to which the cutter is coupled, and the cutter may include a cutter coupling groove passing through the cutter so as to be coupled to the cutter housing.

A vacuum cleaner may include a main body including a fan, a motor connected to the fan, and configured to rotate the fan to generate an intake force, and an intake head connected to the main body to guide foreign substances to be drawn into the main body therethrough by the intake force. The intake head may include a housing including an inlet, a drum brush rotatable within the housing to allow foreign substances to be drawn into the housing through the inlet, and the drum brush including a drum body, a brush on an outer circumference of the drum body, and a blade around the brush, and a cutter including a plurality of cutting edges protruding toward the brush and adjacent to the brush to remove foreign substances wound on the brush, and a plurality of catching grooves formed concavely and inclined with respect to a direction perpendicular to an axial direction of the drum brush to cause foreign substances to be caught.

The plurality of cutting edges may be arranged to be spaced apart from each other along the axial direction of the drum body, and the plurality of catching grooves may be disposed between the plurality of adjacent cutting edges.

The cutter may extend along the axial direction of the drum brush.

The cutter may further include a left cutting portion and a right cutting portion respectively disposed on the left and right in the axial direction of the drum brush, and the plurality of catching grooves included in the right cutting portion may be inclined in an opposite direction to the plurality of catching grooves included in the left cutting portion.

The cutter may further include an upstream cutting portion and a downstream cutting portion disposed on a downstream side of the upstream cutting portion with respect to a direction of rotation of the drum brush, and the downstream cutting portion may include a pair of adjacent catching grooves and the upstream cutting portion may include a catching groove disposed between the pair of adjacent catching grooves of the downstream cutting portion in the axial direction of the drum brush.

The upstream cutting portion may include a first cutting portion and a second cutting portion respectively disposed on the left and right in the axial direction of the drum brush, the downstream cutting portion may include a third cutting portion and a fourth cutting portion disposed on the left and right in the axial direction of the drum brush, the first cutting portion and the fourth cutting portion may be respectively disposed on the left and right in the axial direction of the drum brush, and the plurality of catching grooves included in the first cutting portion and the fourth cutting portion may be inclined in opposite directions to the plurality of catching groves included in the second cutting portion and the third cutting portion.

### Advantageous Effects

According to various embodiments of the present disclosure, foreign substances, such as hair, animal fur, thread, and the like wound on a drum brush may be removed from the drum brush by a cutter.

According to various embodiments of the present disclosure, foreign substances removed from a drum brush may be cut by a cutter.

### DESCRIPTION OF DRAWINGS

FIG. 1 is a view illustrating a vacuum cleaner according to an embodiment of the present disclosure.

FIG. 2 is a perspective view of an intake head of the vacuum cleaner shown in FIG. 1.

FIG. 3 is an exploded view of the intake head of the vacuum cleaner shown in FIG. 1.

FIG. 4 is a perspective view of a drum brush of the vacuum cleaner shown in FIG. 1.

FIG. 5 is a cross-sectional view of the drum brush of the vacuum cleaner shown in FIG. 1.

FIG. 6 is a view illustrating an arrangement of the drum brush and a cutter of the vacuum cleaner shown in FIG. 1.

FIG. 7 is a perspective view of the cutter of the vacuum cleaner shown in FIG. 1.

FIG. 8 is a cross-sectional view of the vacuum cleaner shown in FIG. 1.

FIG. 9 is a cross-sectional view of the vacuum cleaner of FIG. 1 illustrating foreign substances being drawn into the vacuum cleaner and cut by the cutter.

FIG. 10 is a view illustrating an embodiment of the cutter of the vacuum cleaner shown in FIG. 1.

FIG. 11 is a view illustrating another embodiment of the cutter of the vacuum cleaner shown in FIG. 1.

FIG. 12 is a view illustrating still another embodiment of the cutter of the vacuum cleaner shown in FIG. 1.

### MODES OF THE INVENTION

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms first, second, primary, secondary, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

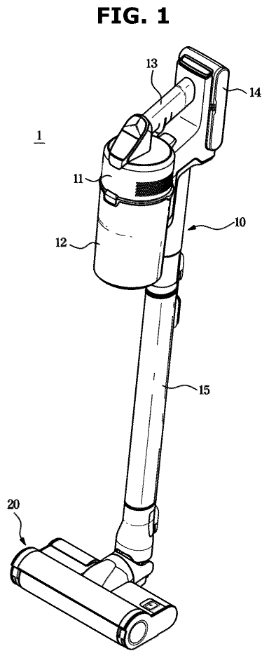

The directions of front, rear, top, bottom, left and right will be referred to uniformly throughout the specification with reference to the directions shown in FIG. 1 of the accompanying drawings. FIG. 1 shows an X-axis, a Y-axis, and a Z-axis direction perpendicular to each other, wherein the X-axis direction may refer to a side-to-side direction of a vacuum cleaner 1, the Y-axis direction may refer to an up-and-down direction of the vacuum cleaner 1, and the Z-axis direction may refer to a front-to-back direction of the vacuum cleaner 1.

Hereinafter, embodiments according to the present disclosure will be described in more detail with reference to the accompanying drawings.

FIG. 1 is a view illustrating a vacuum cleaner according to an embodiment of the present disclosure.

The vacuum cleaner 1 may include a main body 10, an intake head 20, and an extension pipe 15 connecting the main body 10 and the intake head 20.

The main body 10 may include an intake force generating device 11 that generates an intake force (also referred to as a suction force), a foreign substance collecting chamber 12 that separates and collects foreign substances from the drawn-in air, a handle 13, and a battery 14 capable of supplying power to the intake force generating device 11.

The intake force generating device 11 may include a motor that converts electrical power into mechanical rotational force, and a fan that is connected to the motor and rotates. The foreign substance collecting chamber 12 may collect foreign substances using a cyclone method, which separates foreign substances using centrifugal force, or a dust bag method, which separates foreign substances by passing air through a filter bag. Air from which foreign substances is removed by the foreign substance collecting chamber 12 may be discharged to an outside of the main body 10.

The extension pipe 15 may be formed of a pipe or flexible hose with a certain stiffness. The extension tube 15 may transmit the intake force generated by the intake force generating device 11 to the intake head 20, and guide the air and foreign substances drawn through the intake head 20 to the main body 10.

The intake head 20 may be in close contact with a cleaning surface and may draw in air and foreign substances from the cleaning surface. The intake head 20 may be rotatably coupled to the extension pipe 15.

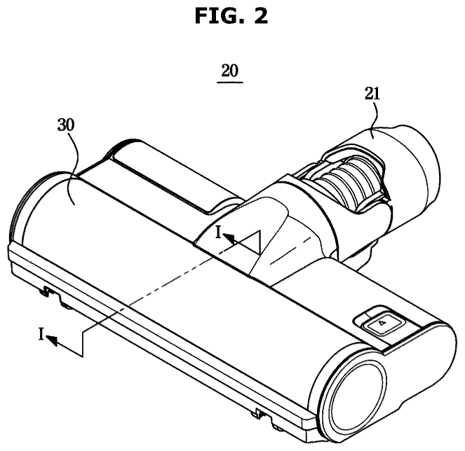

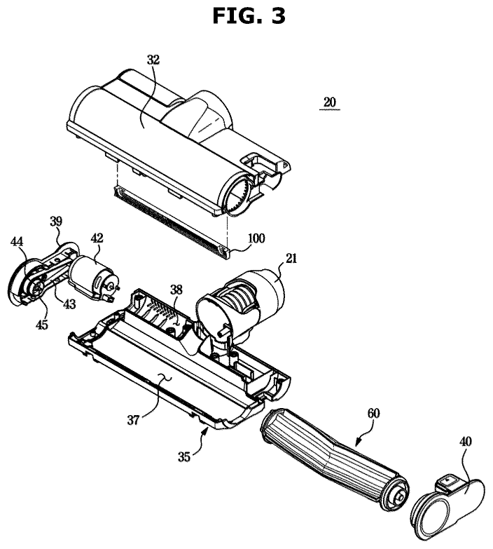

FIG. 2 is a perspective view showing the intake head of the vacuum cleaner according to the present disclosure. FIG. 3 is an exploded view of the intake head of the vacuum cleaner according to an embodiment of the present disclosure.

Referring to FIGS. 2 and 3, the intake head 20 may include a housing 30 with an inlet 37, and a drum brush 60 that rotates to cause foreign substances to be effectively drawn into an interior of the housing 30 through the inlet 37, a cutter 100 that cuts and removes foreign substances wound on the drum brush 60 from the drum brush 60, and a connector 21 that connects the housing 30 and the extension tube 15.

The housing 30 may be formed by assembling an upper housing 32, a lower housing 35, a left side cover 39, and a right side cover 40.

The inlet 37 may be formed in the lower housing 35. Air and foreign substances drawn into the interior of the housing 30 through the inlet 37 may be discharged to the outside of the housing 30 through the connector 21. The inlet 37 may be formed in the lower housing 35 along a longitudinal direction 31 of the housing 30. The connector 21 may be formed at a central portion of the housing 30 in the longitudinal direction.

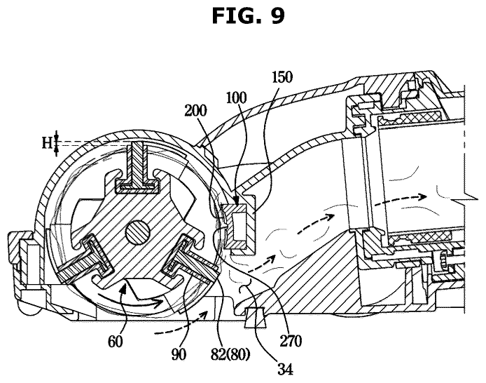

A connection hole 34 (see FIG. 9) connected to the connector 21 may be formed in the upper housing 32.

The drum brush 60 may be rotatably disposed within the housing 30. A detailed description of the drum brush 60 will be described later.

The intake head 20 may include a driver that provides a rotational force to rotate the drum brush 60. The driver may include a motor 42 that generates the rotational force, a pulley 44 having a coupler 45 to which the drum brush 60 is coupled, and a belt 43 that transmits the rotational force of the motor 42 to the pulley 44. A motor room 38 in which the motor 42 is received may be formed in the housing 30.

The cutter 100 may include a plurality of cutting edges 200. A detailed description of the cutter 100 will be described later.

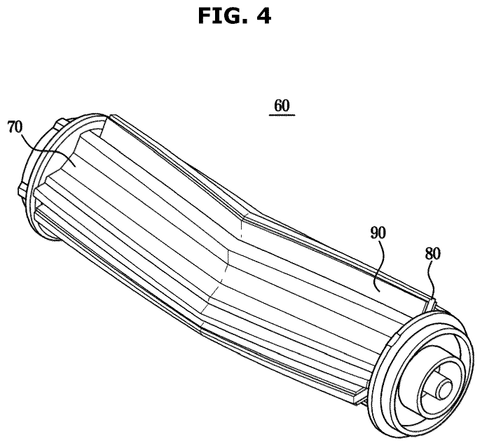

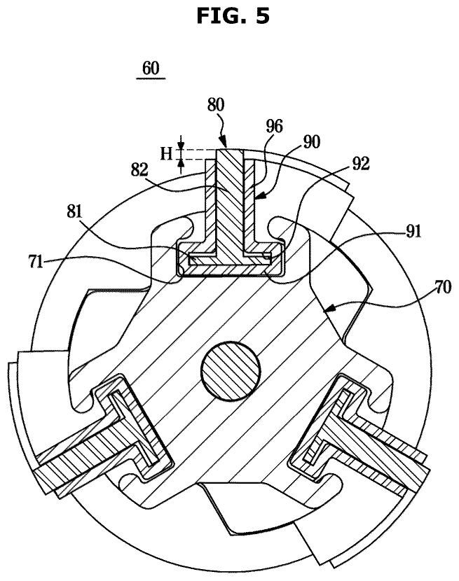

FIG. 4 is a perspective view of the drum brush, and FIG. 5 is a cross-sectional view of the drum brush.

The drum brush 60 may include a drum body 70, a brush 80 provided around an outer circumference of the drum body 70 to sweep the cleaning surface to scatter foreign substances, and a blade 90 provided around the brush 80.

Referring to FIG. 5, the brush 80 may include a brush band 81 extending laterally between opposite axial ends of the drum body 70 and a plurality of brush bristles 82 protruding from the brush band 81. The plurality of brush bristles 82 may be formed to be spaced apart from each other at a predetermined interval along the brush band 81.

A portion of the brush 80 adjacent to an side end of the drum body 70 may be located on a rear side in a direction of rotation of the drum brush 60, and a portion thereof adjacent to the center of the brush 80 may extend in a spiral shape so as to be located on a front side in the direction of rotation of the drum brush 60. In other words, the brush 80 may be arranged in a substantially V-shape so as to transfer foreign substances to the center of the drum brush 60 during rotation of the drum brush 60.

As such, since the plurality of brush bristles 82 are formed to be spaced apart from each other at a predetermined interval, foreign substances, such as hair, animal fur, and thread may be caught between the plurality of brush bristles 82. When such foreign substances are caught between the plurality of brush bristles 82, the foreign substances may be wound around the drum brush 60 during the rotation of the drum brush 60. The foreign substances wound around the drum brush 60 may remain on the drum brush 60 regardless of the suction power of the main body 10, thereby reducing the cleaning efficiency of the vacuum cleaner 1 or further restricting the rotation of the drum brush 60.

To prevent foreign substances from being wound around the drum brush 60, the drum brush 60 may include the blade 90 extending along the brush band 81 in a vicinity of the brush 80.

The blade 90 may include a blade base 91 that is inserted and coupled to a coupling groove 71 formed on the outer circumference of the drum body 70, and a blade body 96 extending from the blade base 91 in a radial direction of the drum body 70. The coupling groove 71 may be formed on the outer circumference of the drum body 70 in order to extend laterally between opposite ends in an axial direction of the drum body 70.

The height of the blades 90 protruding from the outer circumference of the drum body 70 may be less than the height of the brush bristles 82 protruding from the outer circumference of the drum body 70 so that the brush bristles 82 do not obstruct the sweeping of the cleaning surface. In other words, the brush 80 may protrude further than the blade 90 by a height of H in the radial direction of the drum body 70. Such a configuration may allow the blade body 96 not to contact the cleaning surface.

The blade base 91 may include a mounting groove 92 into which the brush band 81 of the brush 80 is inserted and coupled. The mounting groove 92 may be formed to extend between opposite ends of the blade base 91 in the longitudinal direction.

In such a configuration, the brush band 81 of the brush 80 may be inserted into the mounting groove 92 of the blade 90 to facilitate assembly of the blade 90 and the brush 80.

Then, the blade base 91 of the blade 90 may be inserted into the coupling groove 71 formed on the outer circumference of the drum body 70 to facilitate mounting the blade 90 and the brush 80 on the drum body 70.

As described above, the configurations of the blade 90 may prevent or reduce foreign substances from being caught between the plurality of brush bristles 82. However, foreign substances, such as hair, animal fur, thread, or the like may still be wound on the drum brush 60. In particular, foreign substances may be trapped concentratedly at a portion of the height H at which that the brush bristles 82 protrude further than the blade 90, resulting in the foreign substances being wound around the drum brush 60. The intake head 20 according to the present disclosure may include the cutter 100 to remove the foreign substances wound on the drum brush 60 from the drum brush 60.

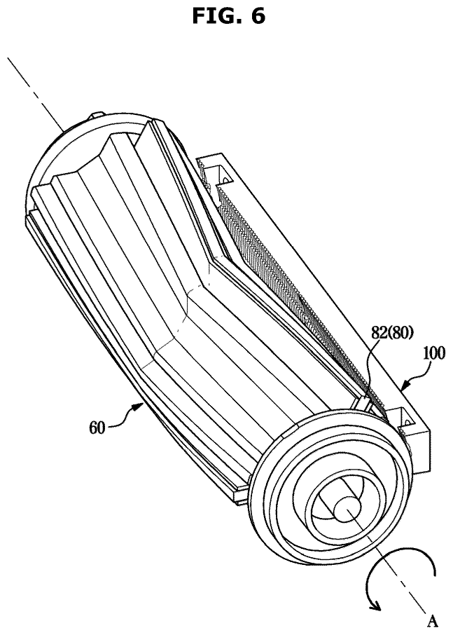

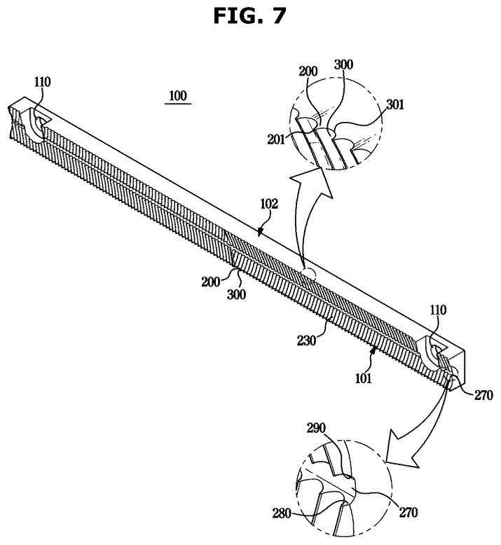

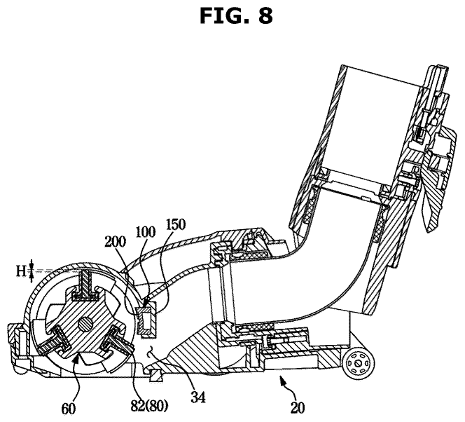

FIG. 6 is a view showing an arrangement of the drum brush and the cutter, and FIG. 7 is a perspective view of the cutter. FIG. 8 is a cross-sectional view of the vacuum cleaner, and FIG. 9 is a cross-sectional view showing the foreign substances being drawn into the vacuum cleaner and cut by the cutter.

The cutter 100 may be disposed adjacent to the drum brush 60 so as to be in contact with foreign substances wound on the drum brush 60. The cutter 100 may be in contact with the drum brush 60 to remove foreign substances wound on the drum brush 60 from the drum brush 60. The cutter 100 may be disposed adjacent to the brush 80.

As the drum brush 60 rotates along an axis A, foreign substances wound on the drum brush 60 may come into contact with the cutter 100 and be removed by the cutter 100. The cutter 100 may contact the brush bristles 82 to remove foreign substances trapped between the plurality of brush bristles 82.

As the drum brush 60 continues to rotate, foreign substances may continue to be captured by the cutter 100 and may be cut by the cutter 100.

The cutter 100 may be arranged parallel to the axis A of rotation of the drum brush 60. The cutter 100 may be arranged to extend longitudinally along the axial direction A of the drum brush 60. The cutter 100 may cover the drum brush 60 from one end to the other end. A length of the cutter 100 may correspond to a length of the drum brush 60.

Referring to FIG. 7, the cutter 100 may include a cutting portion 101 and a body portion 102.

The cutting portion 101 may contact the drum brush 60 to cut and remove foreign substances wound around the drum brush 60. The cutting portion 101 may include the plurality of cutting edges 200, a plurality of catching grooves 300, and a cutting groove 270.

The body portion 102 may support the cutting portion 101 and may be formed to extend from the cutting portion 101. The body portion 102 may include a block shape extending longitudinally along the axial direction of the drum brush 60. The body portion 102 may include a cuboidal shape.

The cutting portion 101 may be provided on one side of the body portion 102. The cutting portion 101 may be provided on one surface of the body portion 102 facing the drum brush 60. The cutting portion 101 may be formed integrally with the body portion 102.

The cutting portion 101 may include the plurality of cutting edges 200. The cutting edges 200 may protrude toward the drum brush 60. The cutting edges 200 may protrude toward the brush 80. The cutting edges 200 may extend along the circumferential direction of the drum brush 60. Each of the cutting edges 200 may include a first curved surface provided on one side and a second curved surface provided on the other side, and an upper end 201 of the cutting edge may be formed at a point where the first curved surface and the second curved surface meet.

The plurality of cutting edges 200 may be arranged along the axial direction of the drum brush 60. The plurality of cutting edges 200 may be arranged to be spaced apart from each other. The plurality of cutting edges 200 may be disposed adjacent to the brush 80.

The cutting portion 101 may include the catching grooves 300. Each of the catching grooves 300 may be disposed between a pair of adjacent cutting edges 200. In other words, because the plurality of cutting edges 200 are arranged to be spaced apart from each other, the catching grooves 300 which are recessed in a direction opposite to a protruding direction of the cutting edges 200 may be formed between adjacent cutting edges 200.

The catching groove 300 may each be provided to be curved and concave. The catching groove 300 may have a semi-cylindrical recessed shape toward the body portion 102. The plurality of catching grooves 300 may be provided.

The cutting portion 101 may include the cutting groove 270. The cutting groove 270 may be in the shape of a groove extending along the axial direction of the drum brush 60. The cutting groove 270 may be provided at the center of the cutter 100. The cutting groove 270 may be formed by being recessed toward the body portion 102.

The cutting portion 101 may include an upstream cutting portion 230 and a downstream cutting portion 240 disposed along the direction of rotation of the drum brush 60. The downstream cutting portion 240 may be disposed on a downstream side of the upstream cutting portion 230 with respect to the direction of rotation of the drum brush 60. The upstream cutting portion 230 and the downstream cutting portion 240 may be arranged in a vertical direction.

The cutting groove 270 may be disposed between the upstream cutting portion 230 and the downstream cutting portion 240. The cutting groove 270 may include upstream edges 280 and downstream edges 290. The upstream edge 280 may include a corner formed by bending from the upstream cutting portion 230 to the cutting groove 270. The downstream edge 290 may include a corner formed by bending from the downstream cutting portion 240 to the cutting groove 270.

The upstream edge 280 and the downstream edge 290 may extend from the cutting edge 200.

The cutter 100 may include a cutter coupling groove 110. The cutter 100 may be coupled to a cutter housing 150 by the cutter coupling groove 110 (see FIGS. 8 and 9), and may be positioned within the intake head 20. The cutter coupling groove 110 may include a through-hole passing through the cutter 100. The cutter coupling grooves 110 may be provided in a plurality and may be provided in positions symmetrical to each other.

The drum brush 60 may rotate to pick up foreign substances from the cleaning surface. For ease of description, the foreign substances may hereinafter be referred to as hair. Hair may be trapped between the plurality of brush bristles 82.

The hair trapped between the plurality of brush bristles 82 may be wound on the drum brush 60 by the rotation of the drum brush 60. Then, the cutter 100 may contact the drum brush 60 to remove the hair wound on the drum brush 60. In particular, the cutter 100 may contact the brush 80 to remove the hair caught on the brush 80.

A height from a lower end 301 of the catching groove 301 to the upper end 201 of the cutting edge may correspond to the height H at which the brush 80 protrudes further in the radial direction of the drum body 70 than the blade 90. In other words, since the maximum protruding height of the cutting edge 200 of the cutter 100 corresponds to H, the cutting edge 200 may reduce the resistance by minimizing contact with the blade 90 and, at the same time, may remove the hair by contacting a portion on which the hair is concentrated.

The hair caught on the brush 80 may be cut and removed from the brush 80 by the cutting edges 200. The hair caught on the brush 80 may be caught in the catching grooves 300 of the cutter 100.

A single strand of hair may be caught in the plurality of catching grooves 300. For example, a portion of a single strand of hair may be caught in the catching grooves 300, while another portion thereof is still be wound on the drum brush 60. In this case, as the drum brush 60 continues to rotate, another portion thereof may also be moved to the cutter 100 and cut by the cutting edges 200.

In addition, a portion of a single strand of hair may be caught in the catching grooves 300 of the upstream cutting portion 230, and another portion thereof may be caught in the catching grooves 300 of the downstream cutting portion 240. In this case, the hair may be cut by the cutting groove 270. In particular, the hair may be cut by the upstream edges 280 or the downstream edges 290 of the cutting groove 270.

The above operations may be performed continuously by repeated rotation of the drum brush 60, and the hair wound on the drum brush 60 may be chopped by the cutter 100, thereby being removed from the drum brush 60.

Referring to FIGS. 8 and 9, the cutter 100 may be positioned on a rear side of the drum brush 60. By being positioned on a rear side of the intake head 20, the cutter 100 may be prevented from being exposed to the outside, thereby improving the aesthetics of the vacuum cleaner 1.

The cutter 100 may be disposed adjacent to the connection hole 34. The cutter 100 may be disposed on an upper portion of the connection hole 34. As the cutter 100 is disposed on the connection hole 34 side, the hair caught in the catching grooves 300 may be lifted out of the catching grooves 300 by the intake force of the connection hole 34. The lifted hair may be caught again in another catching groove 300, so that a single strand of hair may be caught in the plurality of catching grooves 300. Alternatively, the lifted hair may be cut by the cutting edges 200.

The cutting edges 200 may extend along the circumferential direction of the drum brush 60, and an upper end of the cutting edges 200 may protrude to form a curve corresponding to a rotational trajectory of the brush 80. In other words, a portion of the cutter 100 where the cutter 100 contacts the drum brush 60 may form a curve corresponding to the rotational trajectory of the drum brush 60, so that the resistance of the drum brush 60 to contact the cutter 100 may be minimize while still efficiently removing the hair trapped in the brush bristles 82.

The cutter 100 may be disposed adjacent to the drum brush 60 such that the cutting edges 200 are inserted up to the height H of the portion where the brush bristles 82 protrude from the blade 90.

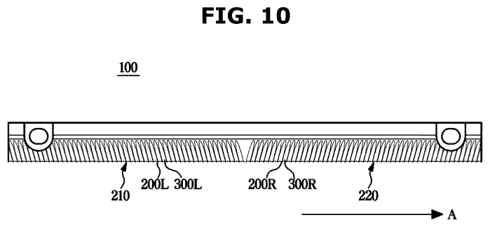

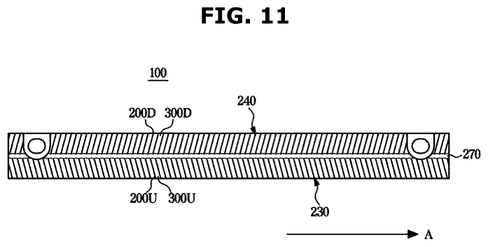

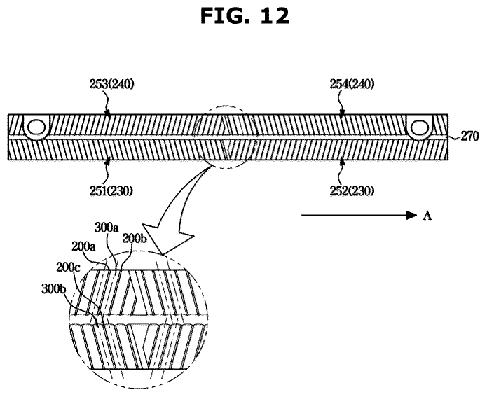

FIG. 10 is an embodiment of the cutter, FIG. 11 is another embodiment of the cutter, and FIG. 12 is a view showing still another embodiment of the cutter.

Referring to FIG. 10, the cutting edges 200 may extend along the circumferential direction of the drum brush 60 and may be inclined with respect to a direction perpendicular to the axial direction A of the drum brush 60. Since the cutting edges 200 are inclined, the catching grooves 300 formed between adjacent cutting edges 200 may also be inclined.

By sloping the catching grooves 300 with respect to the direction perpendicular to the axial direction A of the drum brush 60, the hair may be caught by the cutter 100 in an inclined state with respect to the direction perpendicular to the axial direction A of the drum brush 60. As a result, although the drum brush 60 rotates in the axial direction A and rubs against the hair caught in the catching grooves 300, the hair may be difficult to escape from the catching grooves 300.

The cutting portion 101 may include a left cutting portion 210 and a right cutting portion 220 disposed on the left and right in the axial direction of the drum brush 60. A plurality of cutting edges 200R included in the right cutting portion 220 may be inclined in an opposite direction to a plurality of cutting edges 200L included in the left cutting portion 210. In other words, catching grooves 300R and 300L may be inclined in opposite directions relative to each other with respect to the axial direction of the drum brush 60. A single strand of hair may be caught in the plurality of catching grooves 300R and 300L arranged in opposite directions. As a result, although the drum brush 60 rotates about its axis and rubs against the hair caught in the catching grooves 300R and 300L, the hair may not be easily released from the catching grooves 300.

Referring to FIG. 11, the cutting portion 101 may include the upstream cutting portion 230 and the downstream cutting portion 240 disposed on the upstream and downstream sides, respectively, in the direction of rotation of the drum brush 60. A plurality of cutting edges 200U included in the upstream cutting portion 230 may be inclined in an opposite direction to a plurality of cutting edges 200D included in the downstream cutting portion 240. In other words, catching grooves 300U and 300D may be inclined in opposite directions with respect to a perpendicular direction of the axis of the drum brush 60. A single strand of hair may be caught in the plurality of catching grooves 300U and 300D arranged in opposite directions. As a result, although the drum brush 60 rotates about its axis and rubs against the hair caught in the catching grooves 300U and 300D, the hair may be prevented from easily escaping from the catching grooves 300U and 300D. In the accompanying drawings, the cutting portion 101 is shown as an example including one cutting groove 270 and including the upstream cutting portion 230 and the downstream cutting portion 240 arranged vertically with respect to the cutting groove 270, but is not limited thereto. For example, the cutting portion 101 may include two or more cutting grooves 270, and may also include three or more cutting portions 101 arranged up and down with respect to the cutting grooves 270.

Referring to FIG. 12, the downstream cutting portion 240 may include a pair of adjacent cutting edges 200a and 200b, and the upstream cutting portion 230 may include a cutting edge 200c disposed between the pair of adjacent cutting edges 200a and 200b of the downstream cutting portion 240 in the axial direction of the drum brush 60. In other words, the plurality of cutting edges 200a and 200b included in the downstream cutting portion 240 and the plurality of cutting edges 200c included in the upstream cutting portion 230 may be arranged to be staggered.

Accordingly, a plurality of catching grooves 300a and 300b included in the downstream and upstream cutting portions 240 and 230, respectively, may be arranged to be staggered with each other. A single strand of hair may be caught in the plurality of catching grooves 300a and 300b arranged to be staggered. As a result, although the drum brush 60 rotates about its axis and rubs against the hair caught in the catching grooves 300a and 300b, the hair may be prevented from easily escaping from the catching grooves 300a and 300b.

Furthermore, the upstream cutting portion 230 may include a first cutting portion 251 and a second cutting portion 252 disposed on the left and right in the axial direction of the drum brush, and the downstream cutting portion 240 may include a third cutting portion 253 and a fourth cutting portion 254 disposed on the left and right in the axial direction of the drum brush. The first cutting portion 251 and the fourth cutting portion 254 may be disposed on the left and right in the axial direction of the drum brush, and the plurality of cutting edges 200 included in the first and fourth cutting portions 251 and 254 may be inclined in opposite directions with respect to the plurality of cutting edges 200 included in the second and third cutting portions 252 and 253.

In other words, the cutting portion 101 may include the cutting edges 200 and the catching grooves 300, which are inclined in opposite directions up, down, left, and right and arranged to be staggered with each other. A single strand of hair may be caught in the plurality of catching grooves 300a and 300b arranged in opposite directions and to be staggered with each other. As a result, although the drum brush 60 rotates about its axis and rubs against the hair caught in the catching grooves 300a and 300b, the hair may be prevented from easily escaping from the catching grooves 300a and 300b.

While the present disclosure has been particularly described with reference to exemplary embodiments, it should be understood by those of skilled in the art that various changes in form and details may be made without departing from the spirit and scope of the present disclosure.

What is claimed is:

1. A vacuum cleaner comprising:
a main body including:
a fan;
a motor connected to the fan, and configured to rotate the fan to generate an intake force; and
an intake head connected to the main body to guide foreign substances to be drawn into the main body therethrough by the intake force;
wherein the intake head includes:
a housing including an inlet;
a drum brush rotatable within the housing to allow the foreign substances to be drawn into the housing through the inlet, the drum brush including:
a drum body; and
a brush on an outer circumference of the drum body; and
a cutter adjacent to the brush, the cutter including:
a plurality of cutting edges arranged along an axial direction of the drum brush to allow the foreign substances wound on the drum brush to be cut and removed from the drum brush.

2. The vacuum cleaner of claim 1, wherein
the plurality of cutting edges protrudes toward the brush and is arranged to be spaced apart from each other, and
the cutter further includes a catching groove concavely formed between the plurality of adjacent cutting edges such that the foreign substances removed from the drum brush are caught.

3. The vacuum cleaner of claim 2, wherein the plurality of cutting edges extends along a circumferential direction of the drum brush and is inclined with respect to a direction perpendicular to the axial direction of the drum brush.

4. The vacuum cleaner of claim 3, wherein
the cutter further includes a left cutting portion and a right cutting portion respectively disposed on the left and right in the axial direction of the drum brush, and
the plurality of cutting edges included in the right cutting portion is inclined in an opposite direction to the plurality of cutting edges included in the left cutting portion.

5. The vacuum cleaner of claim 3, wherein the cutter further comprises:
an upstream cutting portion;
a downstream cutting portion disposed on a downstream side of the upstream cutting portion with respect to a direction of rotation of the drum brush; and
a cutting groove recessed between the upstream cutting portion and the downstream cutting portion in a direction opposite to a protruding direction of the cutting edges, the cutting groove including:
an upstream edge having a corner bent from the upstream cutting portion; and
a downstream edge having a corner bent from the downstream cutting portion.

6. The vacuum cleaner of claim 5, wherein the downstream cutting portion includes a pair of adjacent cutting edges, and the upstream cutting portion includes a cutting edge disposed between the pair of adjacent cutting edges of the downstream cutting portion in the axial direction of the drum brush.

7. The vacuum cleaner of claim 6, wherein the plurality of cutting edges included in the upstream cutting portion is inclined in an opposite direction to the plurality of cutting edges included in the downstream cutting portion.

8. The vacuum cleaner of claim 6, wherein
the upstream cutting portion includes a first cutting portion and a second cutting portion respectively disposed on the left and right in the axial direction of the drum brush,
the downstream cutting portion includes a third cutting portion and a fourth cutting portion respectively disposed on the left and right in the axial direction of the drum brush, and
the plurality of cutting edges included in the first cutting portion and the fourth cutting portion are inclined in opposite direction to the plurality of cutting edges included in the second cutting portion and the third cutting portion.

9. The vacuum cleaner of claim 2, wherein the plurality of cutting edges extends along a circumferential direction of the drum brush, and upper ends of the plurality of cutting edges protrude to form a curve corresponding to a rotational trajectory of the brush.

10. The vacuum cleaner of claim 2, wherein
the intake head further includes a blade extending along the axial direction of the drum body around the brush to prevent the foreign substances from being caught in the brush, and
the brush protrudes further in a radial direction of the drum body than the blade.

11. The vacuum cleaner of claim 10, wherein
a maximum height from a lower end of the catching groove to an upper end of the cutting edge corresponds to a height at which the brush protrudes further in the radial direction of the drum body than the blade.

12. The vacuum cleaner of claim 1, wherein the housing includes a connection hole to allow the foreign substances drawn into the housing to move to the main body therethrough,
wherein the cutter is disposed on a rear side of the drum brush and on an upper portion of the connector.

13. The vacuum cleaner of claim 1, wherein the cutter is parallel to an axis of rotation of the drum brush.

14. The vacuum cleaner of claim 1, wherein
the intake head further includes a cutter housing to which the cutter is coupled, and
the cutter includes a cutter coupling groove passing through the cutter so as to be coupled to the cutter housing.

15. A vacuum cleaner comprising:
a main body including:
a fan;
a motor connected to the fan, and configured to rotate the fan to generate an intake force; and
an intake head connected to the main body to guide foreign substances to be drawn into the main body therethrough by the intake force;
wherein the intake head includes:
a housing including an inlet;
a drum brush rotatable within the housing to allow foreign substances to be drawn into the housing through the inlet, the drum brush including:
a drum body;
a brush on an outer circumference of the drum body; and
a blade around the brush; and
a cutter including:
a plurality of cutting edges protruding toward the brush, and adjacent to the brush to remove foreign substances wound on the brush; and
a plurality of catching grooves formed concavely and inclined with respect to a direction perpendicular to an axial direction of the drum brush to cause the foreign substances to be caught.
